(19) United States
(12) Patent Application Publication
(10) Pub. No.: US 2007/0209603 A1
(43) Pub. Date: Sep. 13, 2007

(54) Animal lifter

(76) Inventor: John James Steinfort, Warragul (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/591,067

(22) PCT Filed: Mar. 22, 2005
(86) PCT No.: PCT/AU05/00408

§ 371 Date: Aug. 30, 2006

(30) Foreign Application Priority Data
Mar. 23, 2004 (AU) 2004901493

(51) Int. Cl. A01K 29/00

(52) U.S. Cl. 119/728

(57) ABSTRACT

An animal lifting and supporting device (1) comprising a frame member (3) having a lifting section (5) and a rear support section (7), a support member (9) depending from the frame member at the rear support section, the support member being constructed so as to project (10) between the hind legs of an animal to support the underneath of the rear of the animal, and a pair of hip supports (11) arranged to depend from the frame member so as to provide support via the hip bones at the opposite sides of the animal, the hip supports being located intermediate the lifting section and the rear support section, wherein the arrangement is such that the animal may be raised or supported in cantilever fashion by lifting or supporting the lifting section.

### FIELD OF THE INVENTION

This invention relates to a device for lifting animals. It relates particularly but not exclusively to a device which may be used to lift the rear portion of cattle and horses to assist them to stand in the event that they are unable to stand by themselves because they are injured or ill.

### BACKGROUND OF THE INVENTION

As a result of injury or illness, it is not uncommon for cattle such as milking cows to find that they are unable to stand without assistance. Of course, without the ability to stand and feed, the cows will die. Even if the cows can be rehabilitated, the time taken to rehabilitate them can be reflected in loss of milking capacity.

Various approaches to rehabilitating cows have been tried. Generally speaking, these techniques typically involve lifting and supporting the cow using a mechanical lifting device to enable the cow to recover while it is held in a standing position. Such approaches have met with a degree of success. However, the lifting devices currently available tend to have certain drawbacks. For example, some constructions whilst they succeed in lifting and supporting the cow can cause the animal considerable pain. Thus after a first use, the animal is very reluctant to accept treatment using such devices a second time. Furthermore, the devices can themselves cause injury.

Other constructions may rely upon a complex arrangement of lifting straps and bars to lift the cow. These can be very cumbersome and hence difficult to use.

The present invention seeks to provide a device for lifting and/or supporting animals which attempts to overcome or ameliorate some of the problems associated with known lifting devices and to provide a more humane approach to lifting and supporting recumbent animals.

### DISCLOSURE OF THE INVENTION

The invention provides in one aspect an animal lifting and supporting device comprising a frame member having a lifting section and a rear support section,
a support member depending from the frame member at the rear support section, the support member being constructed so as to project between the hind legs of an animal to support the underneath of the rear of the animal, and
a pair of hip supports arranged to depend from the frame member so as to provide support via the hip bones at the opposite sides of the animal, the hip supports being located intermediate the lifting section and the rear support section,
wherein the arrangement is such that the animal may be raised or supported in cantilever fashion by lifting or supporting the lifting section.

Suitably, the support member may extend downwardly from the frame member in a generally vertical direction. It may include a leg portion which extends at an angle to the downwardly depending portion. Typically, it may make an angle between 75° and 135° degrees with the downwardly depending portion. The leg may include a support seat which fits between the legs of a cow and is arranged so as to be located to support the underneath of the cow in the region between the anus and the udder in the vicinity of the eustuchion area and under the animal's pelvis.

Suitably, the support member may include means for adjusting its height and hence the height of the support seat relative to the frame member.

Similarly, the hip supports may be adjustable with respect to the frame member. They may be adjustable so as to make them movable lengthwise with respect to the frame member. They also may be adjustable so as to allow them to be pivoted inwardly and/or outwardly with respect to the sides of the cow so that they may be properly located with respect to the hip bones of the cow. For this purpose, they may include an adjustment member. The adjustment member may comprise a threaded rod which is adapted to interact with bolt members provided on each of the hip supports.

The hip supports may include a portion which is generally U-shaped. Thus, the bottom of the U-shape may be designed so as to fit under the hip bones of a cow to provide lift and support. The anterior end of the U-shape (as in the vertical end) positions the device and restrains the animal when the animal steps forward. Unwinding these supports releases the animal when either standing or recumbent.

The lifting section suitably incorporates a member to allow threading of a rope or chain therethrough. This member may comprise a hoop attached at or near the end of the frame member.

The arrangement of the rear support section and hip supports may be such as to provide a cantilever action when the animal is being lifted. The cantilever action may operate to apportion lifting capacity between the hips and the rear support section when lifting and to correctly maintain the location of the rear support section.

The cantilever action also automatically positions the pelvic support seat in the appropriate position to ensure a significant proportion of the lift is taken under the pelvis.

The cantilever action also ensures the pelvic support system is still engaged whilst the animal is standing whilst the hip support system is disengaged—ie. the U-frame has lowered down from the hip bones by 50-100 mm and is only engaging the muscle groups associated with the hips and upper thigh muscles. This assists to maintain the correction (mid-line) alignment of the pelvic support system, no matter how the animal moves away from mechanical lift. The slotted adjustments of the main frame and hip supports can allow the lowering of the hip supports when the animal is nearly or fully independently standing ie. the mechanical lifting system is no longer or only slightly supporting the device and animal.

The hip support device may be designed for 3 functions.
1. Add lift support to pelvis and hind quarter.
2. Locating function—large surface area of the U-structure acts to exact mild pressure over many muscle groups in order to keep the pelvic support system aligned to the mid-line section of the animal ie. to ensure the lift is balanced and to ensure appropriate location when the animal is standing and stepping around.
3. Ensure the lifter remains in position when animal tries to step or walk away with the mechanical lift chain for lifting the device still attached.
Cattle generally settle well when lifted to stand upright. They may then be encouraged to eat/drink whilst the device is in place giving marginal support eg.
   supports→(0-10% wt)
   acts to also “catch’ them if they step and stumble which often happens in the initial standing process
Once their legs and muscles gain strength, which happens quite quickly (ie. to getting rid of their “pins and needles”, most cattle can walk off and require no further treatment.

In a preferred embodiment the hip lifting device may be located half way along the main lifting frame. This ensures good cantilever movement of the pelvic support into the lower pelvic area and engaging beneath the pelvis. The mechanical lift when engaged can pull the main lifting frame from a generally horizontal position to a 40-60° angle. The hip frames rotate to a lesser extend due to the particular construction described with reference to the drawings.

Preferred aspects of the invention will now be described with reference to the accompanying drawings.

### BRIEF DESCRIPTION OF THE DRAWINGS

FIG. 1 shows an exploded view of an animal lifting device according to the invention;

FIG. 2 shows a perspective view of the assembled device of FIG. 1;

FIG. 3 shows the device positioned ready to raise the rear of a cow; and

FIG. 4 shows the device in place when the cow has been lifted.

### DETAILED DESCRIPTION OF THE PREFERRED EMBODIMENTS

The various elements identified by numerals in the drawings are listed in the following integer list.

### INTEGER LIST

1 Lifter
3 Frame member
5 Lifting section
6 Loop
7 Rear support section
9 Rear support member
10 Support seat
11 Hip support
13 Hinge bracket
14 Hinge
17 Hinge bolt
18 Nut
20 Pin
21 Hole/slot
24 Split pin clip
25 Box section
26 Bolt
27 Nut
29 Hole
30 Hole
32 Threaded rod
34 Bracket
36 Tubular portion
38 Pin
40 Slot
42 Hole
44 Clip
45 Screw thread
46 Nut member
47 Round extension
48 Groove
49 Tube
51 Hole
52 Clip
54 U-section
56 Soft covering
60 Cow
62 Hip bone
64 Lifting chain

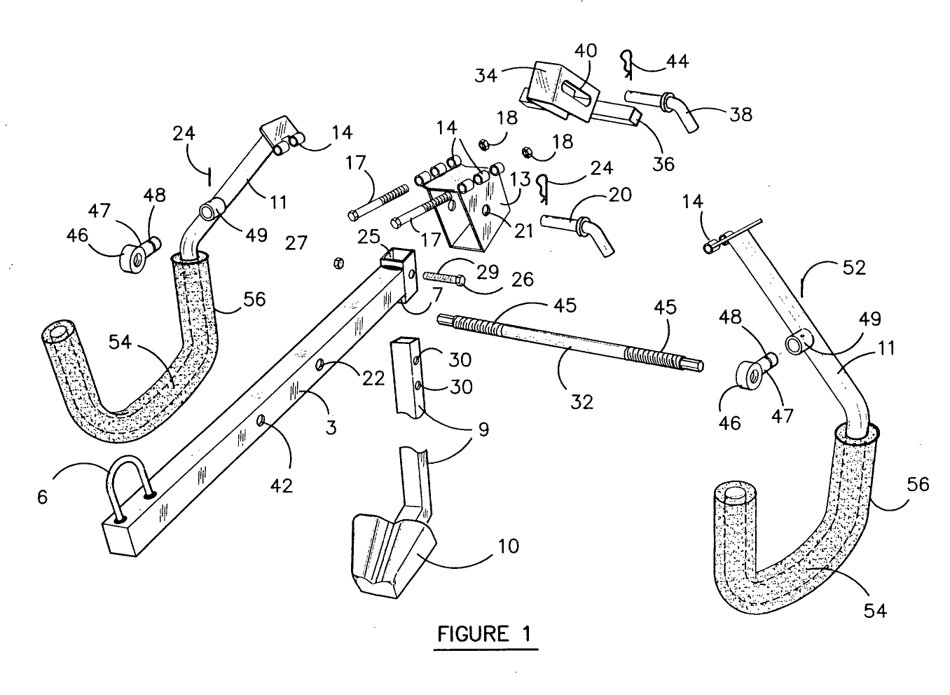

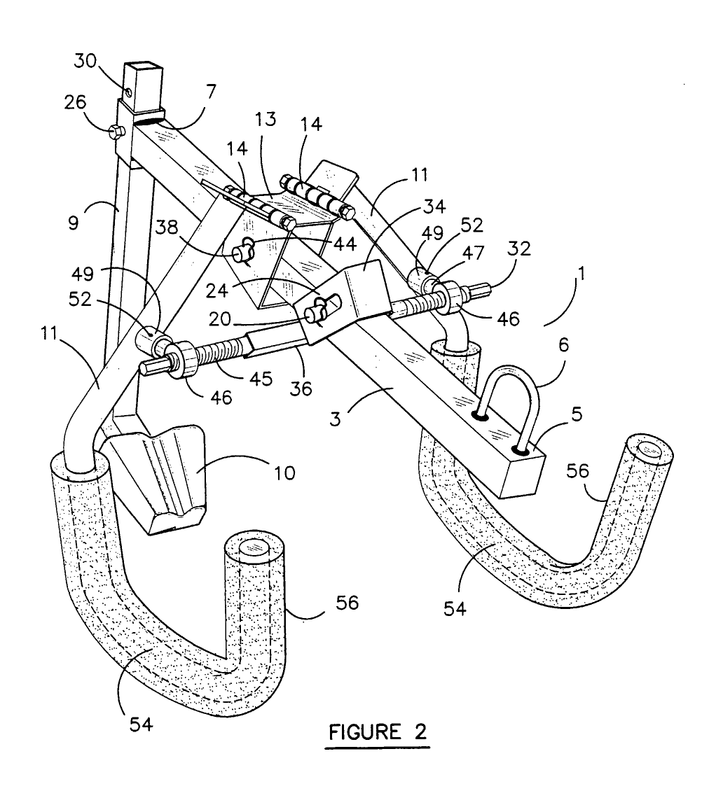

Referring to FIGS. 1 to 4 of the accompanying drawings, the lifter generally designated 1 in the drawings comprises a frame member 3 which may typically be formed of a box section steel tube.

The frame member is provided with a lifting section 5 near one end, the lifting section having a loop 6 for receiving a lifting chain or strap as the case may be.

The other end of the frame member 7 comprises a rear support section for the pelvis. It attaches to a rear support member 9 which depends downwardly generally vertically from the frame member 3. The rear support member includes a support seat 10 at the end of a small leg extending at an angle (typically about 120°) to the generally vertical portion of the rear support member.

Hip supports 11 extend from both sides of the frame member 3 and are joined thereto by a hinge bracket 13 which telescopically slides on to the frame member 3. The hinge bracket includes hinges 14 attaching the hip supports to the bracket. A hinge bolt 17 and nut 18 hold the hinge 14 together.

The hinge bracket itself is fixed in position on the frame member by means of a pin 20 passing through holes/slots 21 and a split pin clip 24 in turn holds the pin locked in position. The construction of the hinge bracket and attachment via the pin to the frame member is such as to allow a moderate degree of relative pivoting between the hinge bracket and the frame member to allow for adjustment of the hip supports for different sized animals. This gives a cantilever action, and releases tension or weight from hip bones when the animal is standing and mostly bearing its own weight. This then stops prolonged pinching under the hip bones.

The rear support section 7 is provided with a box section 25 of steel attached thereto. Thus the rear support member which is also formed as a box section is slidably movable within the box section 25 to allow for adjustment. A series of holes 30 in the rear support member may be used to set the height of the support seat with respect to the level of the frame member 3. A bolt 26 passing through the holes 29 in the box section 25 and the holes 30 in the rear support member 9 secures the rear support member adjustably in place, the nut 27 fitting over the end of the screw threaded bolt 26 to fix the components together.

Adjustment of the separation between the U-sections 54 of the hip supports 11 is achieved using the threaded rod 32.

The threaded rod extends through the tubular portion 36 of bracket 34. In turn the bracket 34 also telescopically slides over the frame member 3 and is held in place by a pin 38 extending through the slot 40 and hole 42. A clip 44 holds the pin in place.

The construction of the bracket 34 in association with the slot 40 is such that there is a degree of play which allows the bracket to pivot with respect to the frame member 3. This in turn allows a degree of lateral movement through an arc of the threaded rod 32 held within the tubular portion 36 of the bracket 34. It is designed to maintain central alignment of pelvic support in relation to hip support and lifting section 5.

The screw threads 45 provided near the ends of the threaded rod 32 screw into the nut members 46. In turn, the nut members have a round extension 47 provided with a groove 48 extending at least part of the way around the circumference of the round extension. The round extension 47 fits snugly into the tube 49 and is held therein by a clip 52 fitting through a hole 51 corner of the clip. The clip locates in the groove to hold the nut member 46 securely within the tube 51 whilst allowing it to rotate with respect to the tube.

The construction of the hip supports and their attachment via the brackets 34 to the frame member allows adjustment of the hip supports with respect to their relative separation simply by rotating the threaded rod 32 to move them in and out with respect to each other as the case may be.

The hip supports have a U-section 54 shaped so as to fit under and support the hip bones of a cow. Suitably, the U-section has a soft covering of material such as foamed plastic or rubber tubing to make the device more comfortable for a cow and to reduce the likelihood of damage to the hips of the cow when it is being lifted.

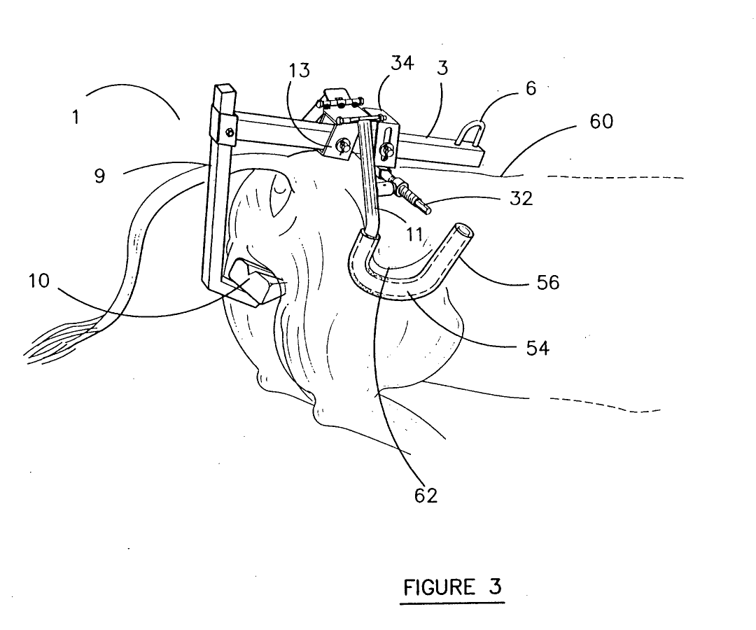

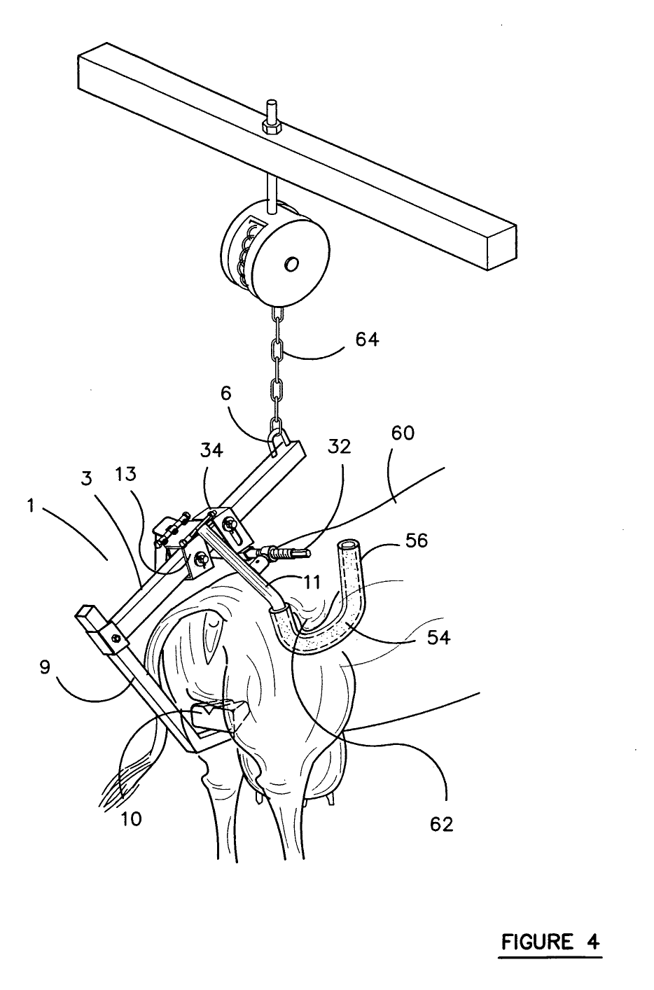

In FIG. 3, it can be seen that the support seat is initially located between the hind legs of a cow between the anus and udder. Thus the support seat exerts upward pressure through the central portion of the pelvic bone. The hip supports have been adjusted so that they immediately underlie the hip bones 62 on either side of the cow. When the lifter 1 is lifted using a lifting chain 64 as shown in FIG. 4, a cantilever effect is brought into play. The hip supports in locating underneath the hip bones cause a general pivoting about their attachment via hinge bracket 13 so that the seat remains firmly pushed underneath the cow and between its legs, thus ensuring that the device remains firmly in place as it lifts the cow.

Because the device distributes lifting forces between three rear portions of the cow, namely the two hips and the pelvic region between the legs at the rear of the cow, the overall force exerted in any single area is significantly reduced making the cow less likely to suffer from pain or other discomfort.

Furthermore, the device is easy to put into place and adjust for a particular cow there being no requirement for strapping to extend around and underneath a cow body.

### EXAMPLE 1

In actual tests of the device on cows the following readings of lifting force were taken when lifting the cow from a recumbent position to a standing position:—

During lifting from a recumbent position:—

| Pelvic Support Seat | Hip Supports Lifting | |
|---|---|---|
| Lifting Force | Force | Total Lifting Force |
| 90 kg | 180 kg | 270 kg |

When the animal was standing:—

| Pelvic Support Seat | Hip Supports Lifting | |
|---|---|---|
| Lifting Force | Force | Total Lifting Force |
| 90 kg | 5-10 kg | 95-100 kg |

In other test, cows which were standing registered the following forces:—

| Pelvic Support Seat | Hip Supports Lifting | |
|---|---|---|
| Lifting Force | Force | Total Lifting Force |
| 50 kg | 0 kg | 50 kg |
| 150 kg | 100 kg | 150 kg |

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge in Australia.

1. An animal lifting and supporting device comprising a frame member having a lifting section and a rear support section, a support member depending from the frame member at the rear support section, the support member being constructed so as to project between the hind legs of an animal to support the underneath of the rear of the animal, and a pair of hip supports arranged to depend from the frame member so as to provide support via the hip bones at the opposite sides of the animal, the hip supports being located intermediate the lifting section and the rear support section, wherein the arrangement is such that the animal may be raised or supported in cantilever fashion by lifting or supporting the lifting section.

2. A device according to claim 1 wherein the support member comprises a generally downwardly directed portion and a leg portion extending generally at an angle to the downwardly directed portion.

3. A device according to claim 2 wherein the angle is between 75 degrees and 135 degrees.

4. A device according to claim 2 wherein the leg portion comprises a support seat located to support a cow in a region between the cow's anus and udder.

5. A device according to claim 4 comprising support member adjustment means for adjusting the height of the support seat relative to the frame member.

6. A device according to claim 1 comprising hinge means pivotally joining an upper portion of each hip support to the frame member.

7. A device according to claim 6 wherein a lower portion of each hip support comprises a generally trough shaped region, with the bottom of the trough shaped region being shaped so as to underlie and support the hip bone of a cow or other animal.

8. A device according to claim 7 wherein the trough shaped region comprises a U-section.

9. A device according to claim 7 wherein the hip supports are held splayed apart on opposite sides of the support frame by a hip adjustment member joining both hip supports.

10. A device according to claim 9 wherein the hip adjustment member comprises a rod provided with screw threads at opposed ends of the rod adapted to screw into screw threaded sockets attached to each of the hip supports whereby the splay at the hip supports may be adjusted by rotating the rod.

11. A device according to claim 10 wherein the rod is held in a tubular member extending transverse to the frame member and the tubular member is pivotally attached to the frame member.

12. A device according to claim 1 comprising a loop member secured to the lifting section.

13. (canceled)
